(19) United States
(12) Patent Application Publication
(10) Pub. No.: US 2025/0340450 A1
(43) Pub. Date: Nov. 6, 2025

(54) METHODS FOR PROCESSING ALKALINE EARTH METAL CARBONATES, TREATED ALKALINE EARTH METAL CARBONATES, AND RELATED COMPOSITIONS AND PRODUCTS INCLUDING TREATED ALKALINE EARTH METAL CARBONATES

(71) Applicant: INCOA Performance Minerals, LLC, Theodore, AL (US)

(72) Inventors: Alexander Pose, East Stroudsburg, PA (US); Joachim Roettle, Mobile, AL (US); Michael Tinkl, Gipf-Oberfrick (CH)

(21) Appl. No.: 19/194,932

(22) Filed: Apr. 30, 2025

Related U.S. Application Data
(60) Provisional application No. 63/640,954, filed on May 1, 2024.

(51) Int. Cl. C01F 11/18; C09C 1/02

(52) U.S. Cl. CPC C01F 11/185; C09C 1/02; C01P 2004/61; C01P 2004/62; C01P 2006/12

(57) ABSTRACT

A method for processing alkaline earth metal carbonate may include introducing alkaline earth metal carbonate into a grinder to form ground alkaline earth metal carbonate. The ground alkaline earth metal carbonate may have a median particle size d₅₀ ranging from about 0.5 microns to about 20 microns, a top cut particle size d₉₈ ranging from about 2 microns to about 100 microns, and a BET surface area ranging from about 0.5 square meters per gram (m²/g) to about 20 m²/g. The method further may include introducing the ground alkaline earth metal carbonate into a high-speed blender, and introducing a treatment agent including a carboxylic acid anhydride into the high-speed blender. The method also may include operating the high-speed blender, thereby to form a surface-treated ground alkaline earth metal carbonate, including carboxylic acid bonded to the ground alkaline earth metal carbonate via a d-acid ligand.

### PRIORITY CLAIM

This U.S. non-provisional patent application claims priority to and the benefit of U.S. Provisional Application No. 63/640,954, filed May 1, 2024, titled “Methods for Processing Alkaline Earth Metal Carbonates, Treated Alkaline Earth Metal Carbonates, and Related Compositions and Products Including Treated Alkaline Earth Metal Carbonates,” the disclosure of which is incorporated herein by reference in its entirety.

### TECHNICAL FIELD

The present disclosure relates to methods for processing alkaline earth metal carbonates, treated alkaline earth metal carbonates, and related compositions and products including treated alkaline earth metal carbonates.

### BACKGROUND

Alkaline earth metal carbonates, such as, for example, calcium carbonates, may be used as particulate fillers in end products including polymer compositions and other compositions. For example, alkaline earth metal carbonates may be incorporated into polymer compositions for forming products including polymer compositions, such as, for example, thermoplastic polymers, thermosetting polymers, and elastomeric polymers. For example, such products may often include a polymer and an alkaline earth metal carbonate, such as calcium carbonate, which may be used as a filler and for other purposes.

The characteristics of the alkaline earth metal carbonate may play an important role in the processing of the composition or may affect characteristics of the composition-containing product. For example, characteristics of alkaline earth metal carbonate may create problems when the alkaline earth metal carbonate is incorporated into, for example, polymer compositions. For example, it may be difficult to sufficiently disperse the alkaline earth metal carbonate throughout the composition during formation of the product containing the alkaline earth metal carbonate. Further, characteristics of the alkaline earth metal carbonate may affect characteristics of products incorporating the alkaline earth metal carbonate, such as the quality and mechanical properties of the product. Thus, it may be desirable to alter characteristics of alkaline earth metal carbonate that will be incorporated into a polymer composition, as well as other compositions.

Accordingly, Applicant has recognized a need for processing alkaline earth metal carbonates in a manner that may result in improved incorporation into polymer compositions or other compositions, which may result in improved processing efficiency, improved processability when incorporated into the compositions, and improved products. The present disclosure may address one or more of the above-referenced considerations, as well as other possible considerations.

### SUMMARY

The present disclosure is generally directed to methods for processing alkaline earth metal carbonates, treated alkaline earth metal carbonates, and related compositions and products including treated alkaline earth metal carbonates. As referenced above, Applicant has recognized that providing an alkaline earth metal carbonate having enhanced characteristics for incorporation into compositions may be desirable, for example, to improve processing efficiency, improve processability when incorporated into compositions, and/or improve products formed by compositions including alkaline earth metal carbonate. In some embodiments, methods for processing alkaline earth metal carbonates with a treatment agent including one or more carboxylic acid anhydrides may result in improvement of processing efficiency, processability, and/or products formed by compositions including the processed alkaline earth metal carbonate.

In some embodiments, a method for processing alkaline earth metal carbonate may include introducing alkaline earth metal carbonate into a grinder to form ground alkaline earth metal carbonate. The ground alkaline earth metal carbonate may have a median particle size d₅₀ ranging from about 0.5 microns to about 20 microns, a top cut particle size d₉₈ ranging from about 2 microns to about 100 microns, and a BET surface area ranging from about 0.5 square meters per gram (m²/g) to about 20 m²/g. The method further may include introducing the ground alkaline earth metal carbonate into a high-speed blender, and introducing a treatment agent into the high-speed blender. The treatment agent may include a carboxylic acid anhydride. The method also may include operating the high-speed blender, thereby to form a surface-treated ground alkaline earth metal carbonate. The surface-treated ground alkaline earth metal carbonate may include carboxylic acid bonded to the ground alkaline earth metal carbonate via a di-acid ligand.

In some embodiments, the method further may include introducing water into the high-speed blender. In some embodiments, the method also may include heating in the high-speed blender the ground alkaline earth metal carbonate and carboxylic acid anhydride to a temperature ranging from about 150 degrees Fahrenheit (F) to about 350 degrees F., for example, a temperature ranging from about 200 degrees F. to about 325 degrees F. For example, in some embodiments, the heating may include heating, via operation of the high-speed blender, the ground alkaline earth metal carbonate and the treatment agent to a temperature of at least about 250 degrees F..

In some embodiments, introducing the treatment agent into the high-speed blender may include introducing the treatment agent in an amount ranging from about 0.1 percent by weight of the ground alkaline earth metal carbonate to about 2 percent by weight of the ground alkaline earth metal carbonate, for example, an amount ranging from about 0.1 percent by weight of the ground alkaline earth metal carbonate to about 0.9 percent by weight of the ground alkaline earth metal carbonate.

In some embodiments, the treatment agent further may include stearic acid. In some such embodiments, a ratio of an amount of the carboxylic acid anhydride to an amount of stearic acid in the treatment agent may range from about 1:5 to about 5:1. In some embodiments, the introduction of the treatment agent into the high-speed blender may include introducing the treatment agent in an amount ranging from about 0.2 percent by weight of the ground alkaline earth metal carbonate to about 1.5 percent by weight of the ground alkaline earth metal carbonate. In some embodiments, the ratio of the amount of the carboxylic acid anhydride to the amount of stearic acid in the treatment agent may range from about 0.8:1 to about 1:0.8. In at least some such embodiments, the introduction of the treatment agent into the high-speed blender may include introducing the treatment agent in an amount ranging from about 0.8 percent by weight of the ground alkaline earth metal carbonate to about one percent by weight of the ground alkaline earth metal carbonate.

In some embodiments, the treatment agent may include alkenyl succinic anhydride. In some embodiments, the alkaline earth metal carbonate introduced into the high-speed blender may have a purity ranging from about 98.6 percent to about 99.8 percent.

In some embodiments, the method further may include drying, via operation of the high-speed blender, the surface-treated ground alkaline earth metal carbonate, such that the surface-treated ground alkaline earth metal carbonate may have a moisture content equal to or less than about 0.2% by weight of the surface-treated ground alkaline earth metal carbonate.

In some embodiments, the surface-treated ground alkaline earth metal carbonate may include unreacted treatment agent equal to or less than about 0.2% by weight of the surface-treated ground alkaline earth metal carbonate.

In some embodiments, the method further may include, prior to introducing the ground alkaline earth metal carbonate into the high-speed blender, supplying unground alkaline earth metal carbonate to a grinder. The method also may include operating the grinder to obtain the ground alkaline earth metal carbonate. The ground alkaline earth metal carbonate may have a median particle size d₅₀ ranging from about 2 microns to about 7 microns, and the operation of the grinder may include supplying an input power to the grinder ranging from about 2% to about 60% less than input power used in conventional grinding processes, for example, from about 5% to about 50% less than conventional grinding processes, from about 5% to about 40% less than conventional grinding processes, from about 5% to about 30% less than conventional grinding processes, from about 5% to about 25% less than conventional grinding processes, from about 5% to about 20% less than conventional grinding processes, from about 5% to about 15% less than conventional grinding processes, from about 5% to about 10% less than conventional grinding processes, from about 10% to about 50% less than conventional grinding processes, from about 15% to about 50% less than conventional grinding processes, from about 20% to about 50% less than conventional grinding processes, from about 25% to about 50% less than conventional grinding processes, from about 30% to about 50% less than conventional grinding processes, from about 40% to about 50% less than conventional grinding processes, from about 20% to about 40% less than conventional grinding processes, or from about 25% to about 35% less than conventional grinding processes.

In some embodiments, a surface-treated alkaline earth metal carbonate may include the surface-treated alkaline earth metal carbonate obtained from one or more of the methods described herein. In some embodiments, a polymer composition may include (a) the surface-treated alkaline earth metal carbonate obtained from one or more of the methods described herein and (b) a polymer. The polymer composition may have one or more of the following characteristics: (a) the polymer may include one or more of a thermoplastic polymer, a thermosetting polymer, or an elastomeric polymer; or (b) the polymer composition may include between about one percent by weight and about 90 percent by weight of the surface-treated alkaline earth metal carbonate.

In some embodiments, a surface-treated alkaline earth metal carbonate may include a ground alkaline earth metal carbonate having a median particle size d₅₀ ranging from about 0.5 microns to about 20 microns, a top cut particle size d₉₈ ranging from about 2 microns to about 100 microns, and a BET surface area ranging from about 0.5 m²/g to about 20 m²/g. The surface-treated alkaline earth metal carbonate further may include a treatment agent including carboxylic acid anhydride bonded to a surface of the ground alkaline earth metal carbonate, thereby to form the surface-treated ground alkaline earth metal carbonate. The surface-treated ground alkaline earth metal carbonate also may include carboxylic acid bonded to the ground alkaline earth metal carbonate via a di-acid ligand.

In some embodiments, the surface-treated ground alkaline earth metal carbonate may have a thermal stability ranging from about 400 degrees F. to about 600 degrees F., for example, a thermal stability ranging from about 450 degrees F. to about 600 degrees F..

In some embodiments, the ground alkaline earth metal carbonate may have a median particle size d₅₀ ranging from about 1 micron to about 5 microns, a top cut particle size d₉₈ ranging from about 4 microns to about 30 microns, and a BET surface area ranging from about one m²/g to about 10 m²/g. In some embodiments, the ground alkaline earth metal carbonate may have a median particle size d₅₀ ranging from about 1.5 microns to about 3.5 microns, a top cut particle size d₉₈ ranging from about 5 microns to about 20 microns, and a BET surface area ranging from about one m²/g to about 10 m²/g.

In some embodiments, a product may include a polymer composition as described herein, the product may be formed via one or more melt-processing methods, and the one or more melt-processing methods may include one or more of extrusion, molding, or mixing. In some embodiments, the product may include one or more of: a film; a stretched film; an un-stretched film; a breathable film; an extrusion coating; fibers; non-wovens; a molded product; a blow-molded product; a roto-molded product; a thermoformed product; an injection-molded product; or a product formed via additive manufacturing.

In some embodiments, a method for manufacturing a polymer product may include combining a surface-treated alkaline earth metal carbonate as described herein with a polymer composition. The method further may include processing the surface-treated alkaline earth metal carbonate and the polymer composition to form the polymer product. The polymer product may include between about one percent by weight and about 90 percent by weight of the surface-treated alkaline earth metal carbonate. In some embodiments, the processing may occur at a processing temperature ranging from about 450 degrees F. to about 550 degrees F..

Still other aspects and advantages of these exemplary embodiments and other embodiments, are discussed in detail herein. Moreover, it is to be understood that both the foregoing information and the following detailed description merely provide illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWING

FIG. 1 is a graph showing test results showing specific grinding energy required in kilowatt-hours per tonne (kWh/t) to achieve respective desired D₉₈ particle sizes for each of (a) a limestone sample according to embodiments of the disclosure and (b) a comparison marble sample.

### DETAILED DESCRIPTION

The following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, intended to mean “including but not limited to,” unless otherwise stated. Thus, the use of such terms is meant to encompass the items listed thereafter, and equivalents thereof, as well as additional items. The transitional phrases “consisting of” and “consisting essentially of,” if present, are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish claim elements.

“Particle size,” unless specified otherwise, as used herein, for example, in the context of particle size distribution (psd), may be measured in terms of equivalent spherical diameter (esd). Particle size properties referred to in the present disclosure may be measured in a well-known manner, for example, by a particle size analyzer marketed by Micromeritics Instrument Corporation™ as a SediGraph™ analyzer, or by a particle size analyzer marketed by Malvern Panalytical™. Such machines may provide measurements and a plot of the cumulative percentage by volume of particles having a size, referred to in the art as “equivalent spherical diameter” (esd), less than the given esd values. For example, the mean or median particle size d₅₀ is the value that may be determined in this way of the particle esd at which there are 50% by volume of the particles that have an esd less than that d₅₀ value. The top cut particle size d₉₈ is the value that may be determined in this way of the particle esd at which there are 98% by volume of the particles that have an esd less than that d₉₈ value. In some instances, particle size may be measured by determining the retained mass on a standardized screen with a mesh size consistent with the median. Other devices and/or methods for measuring and/or characterizing particle size are contemplated.

This disclosure is generally directed to methods for processing alkaline earth metal carbonates, treated alkaline earth metal carbonates, and related compositions and products including treated alkaline earth metal carbonates. For example, a method for processing alkaline earth metal carbonate (e.g., a method for treating alkaline earth metal carbonate) may include introducing alkaline earth metal carbonate into a grinder to form ground alkaline earth metal carbonate. The ground alkaline earth metal carbonate may have a median particle size d₅₀ ranging from about 0.5 microns to about 20 microns, a top cut particle size d₉₈ ranging from about 2 microns to about 100 microns, and a BET surface area ranging from about 0.5 square meters per gram (m²/g) to about 20 m²/g. The method further may include introducing the ground alkaline earth metal carbonate into a high-speed blender, and introducing a treatment agent into the high-speed blender. The treatment agent may include a carboxylic acid anhydride. The method also may include operating the high-speed blender, thereby to form a surface-treated ground alkaline earth metal carbonate. The surface-treated ground alkaline earth metal carbonate may include carboxylic acid bonded to the ground alkaline earth metal carbonate via a di-acid ligand.

In some embodiments, the alkaline earth metal carbonate may include, for example, one or more of carbonates of beryllium, carbonates of magnesium, carbonates of calcium (e.g., calcium carbonate), carbonates of strontium, carbonates of barium, and carbonates of radium. In some embodiments, the alkaline earth metal carbonate may include, for example, any counter ions (e.g., calcium being electronically Ca2+), such as, for example, all generic counter-ions, such as X2− and (X1−)2 that are ionically or covalently bonded to calcium, for example, one or more of calcium bromate, calcium carbonate, calcium chloride, calcium hydroxide, calcium nitrate, calcium nitride, calcium oxide, calcium permanganate, calcium phosphate, dicalcium phosphate, monocalcium phosphate, and calcium citrate. Other alkaline earth metal carbonates are contemplated.

In some embodiments, the treatment agent may include any one or more carboxylic acid anhydrides, including, for example, carboxylic acid anhydrides including alkyl chains of various chain lengths, including, for example, oligomers of such structures and/or polymers of such structures. Without wishing to be bound by theory, it is believed that, surprisingly, carboxylic acid anhydride may be converted to a bis-acid during processing with the alkaline earth metal carbonate via trace amounts of water. In some embodiments, the treatment agent may include alkenyl succinic anhydride. In some embodiments, the treatment agent may include, for example, (a) any bis-acids, tris-acids, tetra-acids, and/or more multiple acids (e.g., also including with 5, −50 acid groups) in general, and/or (b) any bis-acids, tris-acids, tetra-acids, and/or more multiple acids (e.g., also including with 5, −50 acid groups) having alkyl chains of various chain lengths, including, for example, oligomers of such structures and/or polymers of such structures.

In some embodiments, prior to processing with a treatment agent, the alkaline earth metal carbonate (e.g., calcium carbonate-containing mine rock) may be introduced into a primary crusher, which may include, for example, a roll crusher, a cone crusher, a jaw crusher, or an impact crusher, and operating the primary crusher to obtain alkaline earth metal carbonate particles, such that the alkaline earth metal carbonate particles may have a top cut particle size d₉₈ of about 90 microns or less. In some embodiments, the alkaline earth metal carbonate, prior to being introduced into the primary crusher, may have a moisture content ranging from about 0.1% by weight to about 10% by weight (e.g., ranging from about 1.0%, 2.0%, 3.0%, 4.0%, 5.0%, 6.0%, 7.0%, 8.0%, or 9.0% by weight to about 10% by weight). The moisture content may be measured by, for example, a CompuTrac™ moisture balance at a temperature of 150 degrees Celsius. Other devices and protocols for measuring and/or characterizing moisture are contemplated.

In some embodiments, prior to processing with a treatment agent, the alkaline earth metal carbonate particles may be introduced into a primary grinder (e.g., an air-swept stirred media mill, a hammer mill, or any other type of mill), which may be operated to, for example, obtain reduced-size alkaline earth metal carbonate particles, such that the reduced-size alkaline earth metal carbonate particles may have a median particle size d₅₀ of about 60 microns or less, for example, a median particle size d₅₀ of about 50 microns or less, a median particle size d₅₀ of about 45 microns or less, a median particle size d₅₀ of about 40 microns or less, a median particle size d₅₀ of about 35 microns or less, a median particle size d₅₀ of about 30 microns or less, or a median particle size d₅₀ of about 25 microns or less.

In some embodiments, the reduced-size alkaline earth metal carbonate particles may be introduced into a classifier mill (e.g., a ball mill, a ball mill coupled to a classifier, and/or an air classifier mill), which may be operated to obtain further-reduced-size alkaline earth metal carbonate particles (e.g., ground alkaline earth metal), such that the further-reduced-size alkaline earth metal carbonate particles may have a median particle size d₅₀ of about 12 microns or less, for example, a median particle size d₅₀ of about 8 microns or less, a median particle size d₅₀ of about 7.5 microns or less, a median particle size d₅₀ of about 7 microns or less, a median particle size dso of about 6.5 microns or less, a median particle size d₅₀ of about 6 microns or less, a median particle size d₅₀ of about 5.5 microns or less, a median particle size d₅₀ of about 5 microns or less, a median particle size d₅₀ of about 4.5 microns or less, a median particle size d₅₀ of about 4 microns or less, a median particle size d₅₀ of about 3.5 microns or less, a median particle size dso of about 3 microns or less, a median particle size d₅₀ of about 2.5 microns or less, a median particle size d₅₀ of about 2 microns or less, a median particle size d₅₀ of about 1.5 microns or less, a median particle size dso of about 1 micron or less, a median particle size d₅₀ of about 0.8 microns or less, a median particle size d₅₀ of about 0.7 microns or less, a median particle size d₅₀ of about 0.6 microns or less, or a median particle size d₅₀ of about 0.5 microns or less. In some examples of the method, the moisture content of the further-reduced-size alkaline earth metal carbonate particles may be about 0.15% by weight or less, for example, a moisture content of about 0.10% by weight or less, a moisture content of about 0.09% by weight or less, a moisture content of about 0.08% by weight or less, a moisture content of about 0.075% by weight or less, a moisture content of about 0.07% by weight or less, a moisture content of about 0.06% by weight or less, or a moisture content of about 0.05% by weight or less.

In some embodiments, the alkaline earth metal carbonate may include calcium carbonate, and introducing the alkaline earth metal carbonate into the primary crusher may include introducing calcium carbonate into the primary crusher. In some examples, the alkaline earth metal carbonate introduced into the primary crusher may include a raw feed of alkaline earth metal carbonate containing mine rock obtained from a mine. In some examples, the raw feed of the alkaline earth metal carbonate may include calcium carbonate sourced from a reserve providing a particulate metal carbonate that has a minimum purity of, for example, about 95% calcium carbonate, as measured by x-ray fluorescence (XRF), or greater than, for example, about 99% calcium carbonate with a level of acid insoluble minerals below, for example, about 2% or below, for example, about 0.1%. TABLE 1 below provides data related to an example alkaline earth metal carbonate (e.g., calcium carbonate) according to embodiments of the disclosure. Some examples of these acid insoluble minerals may be of a natural size of below, for example, about 5 microns. In some examples of the raw feed, the morphology of the particles may be of a generally rounded shape. As described herein, other types of alkaline earth metal carbonates are contemplated.

TABLE 1
Example Alkaline Earth Metal Carbonate

| Example Characteristics | Data |
|---|---|
| Purity (CaCO₃, %) | 99.48% |
| Magnesium content (%) | 0.46% |
| Acid insolubles content (%) | 0.06% |
| Variability | Low |
| Iron (Fe) content (ppm) | 86 |

In some embodiments, introducing the alkaline earth metal carbonate into the primary crusher may include introducing alkaline earth metal carbonate into the primary crusher that has a purity ranging from about 97.5% to about 99.9%. In some examples, introducing the alkaline earth metal carbonate into the primary crusher may include introducing alkaline earth metal carbonate into the primary crusher that includes about 0.5% by weight or less quartz, or about 0.25% by weight or less quartz. In some embodiments, the alkaline earth metal carbonate introduced into the high-speed blender may have a purity ranging from about 98.6 percent to about 99.5 percent.

In some embodiments, the method for processing alkaline earth metal carbonate further may include, prior to introducing the ground alkaline earth metal carbonate into the high-speed blender, supplying unground alkaline earth metal carbonate to a grinder, for example, as described above. The method also may include operating the grinder to obtain the ground alkaline earth metal carbonate. The ground alkaline earth metal carbonate may have a median particle size dso ranging from about 2 microns to about 7 microns, and the operation of the grinder may include supplying an input power to the grinder ranging from about 2% to about 60% less than input power used in conventional grinding processes, for example, from about 5% to about 50% less than conventional grinding processes, from about 5% to about 40% less than conventional grinding processes, from about 5% to about 30% less than conventional grinding processes, from about 5% to about 25% less than conventional grinding processes, from about 5% to about 20% less than conventional grinding processes, from about 5% to about 15% less than conventional grinding processes, from about 5% to about 10% less than conventional grinding processes, from about 10% to about 50% less than conventional grinding processes, from about 15% to about 50% less than conventional grinding processes, from about 20% to about 50% less than conventional grinding processes, from about 25% to about 50% less than conventional grinding processes, from about 30% to about 50% less than conventional grinding processes, from about 40% to about 50% less than conventional grinding processes, from about 20% to about 40% less than conventional grinding processes, or from about 25% to about 35% less than conventional grinding processes.

In some embodiments, the method for processing the alkaline earth metal carbonate further may include introducing water into the high-speed blender. Without wishing to be bound by theory, it is believed that, surprisingly, in the presence of water (e.g., equimolar amounts of water), the carboxylic acid anhydride may be transformed into a bis-acid, such that the bis-acid bonds to the surface of the alkaline earth metal carbonate, thereby to improve the surface treatment characteristics of the surface-treated alkaline earth metal carbonate, at least in comparison to at least some known calcium carbonate treated with stearic acid (e.g., at least in comparison to (e.g., all) calcium carbonate treated with stearic acid alone). It is further believed, without wishing to be bound by theory, that, surprisingly, this may contribute to (e.g., result in) one or more of the attributes (e.g., improvements) described below with respect to incorporating the carboxylic acid anhydride-treated alkaline earth metal carbonate into compositions, such as, for example, polymer compositions.

In some embodiments, the method also may include heating in the high-speed blender the ground alkaline earth metal carbonate and carboxylic acid anhydride to a temperature ranging from about 150 degrees F. to about 350 degrees F., for example, a temperature ranging from about 200 degrees F. to about 325 degrees F. For example, in some embodiments, the heating may include heating, via operation of the high-speed blender, the ground alkaline earth metal carbonate and the treatment agent to a temperature of at least about 250 degrees F. In at least some embodiments, no additional heater or heating device may be used to heat the ground alkaline earth metal carbonate and the treatment agent. Without wishing to be bound by theory, it is believed that, surprisingly, heating the ground alkaline earth metal carbonate and carboxylic acid anhydride, for example, during the blending, may result in reducing the moisture content of the surface-treated alkaline earth metal carbonate. It is further believed, without wishing to be bound by theory, that, surprisingly, this may contribute to (e.g., result in) one or more of the attributes (e.g., improvements) described below with respect to incorporating the carboxylic acid anhydride-treated alkaline earth metal carbonate into compositions, such as, for example, polymer compositions. In some embodiments, the high-speed blender may include a “paddle type” high-speed blender, for example, which includes a plurality of rotating paddles for combining the alkaline earth metal carbonate and carboxylic acid anhydride. In some embodiments, the high-speed blender may include a heater, such as, for example, a heater including a jacket configured to receive a liquid heating medium, such as, for example, oil. In some embodiments, the high-speed blender may include a plurality of rotating paddles and a heater. Without wishing to be bound by theory, it is believed that, surprisingly, the combination of rotating paddles and a heater may contribute to reducing the moisture content of the carboxylic acid anhydride-treated alkaline earth metal carbonate, for example, relative to other types of blenders, due to a combination of the dwell time in the plurality of paddles and the heater, with the dwell time exposing the ground alkaline earth metal carbonate and carboxylic acid anhydride for a period of time sufficient to heat the ground alkaline earth metal carbonate and carboxylic acid anhydride to a desired temperature. Further, without withing to be bound by theory, it is believed that, surprisingly, this may contribute to (e.g., result in) one or more of the attributes (e.g., improvements) described below with respect to incorporating the carboxylic acid anhydride-treated alkaline earth metal carbonate into compositions, such as, for example, polymer compositions. In some embodiments, a high-speed blender marketed by Scott Equipment Company™, which may include a plurality of paddles and a heater, may be used. Other types of high-speed blending apparatuses are contemplated, such as, for example, a pin mill and/or other types of blenders. In some embodiments, the method further may include drying, via operation of the high-speed blender, the surface-treated ground alkaline earth metal carbonate, such that the surface-treated ground alkaline earth metal carbonate may have a moisture content equal to or less than about 0.2% by weight of the surface-treated ground alkaline earth metal carbonate.

In some embodiments, introducing the treatment agent into the high-speed blender may include introducing the treatment agent in an amount ranging from about 0.1 percent by weight of the ground alkaline earth metal carbonate to about 2 percent by weight of the ground alkaline earth metal carbonate, for example, an amount ranging from about 0.1 percent by weight of the ground alkaline earth metal carbonate to about 0.9 percent by weight of the ground alkaline earth metal carbonate.

In some embodiments, the treatment agent further may include stearic acid. In some embodiments, a ratio of an amount of the carboxylic acid anhydride to the amount of stearic acid in the treatment agent may range from about 1:5 to about 5:1. In some embodiments, the introduction of the treatment agent into the high-speed blender may include introducing the treatment agent, including the carboxylic acid anhydride to the amount of stearic acid, in an amount ranging from about 0.1 percent by weight of the ground alkaline earth metal carbonate to about 10 percent by weight of the ground alkaline earth metal carbonate, for example, an amount ranging from about 0.2 percent by weight of the ground alkaline earth metal carbonate to about 8 percent by weight of the ground alkaline earth metal carbonate, an amount ranging from about 0.2 percent by weight of the ground alkaline earth metal carbonate to about 6 percent by weight of the ground alkaline earth metal carbonate, an amount ranging from about 0.2 percent by weight of the ground alkaline earth metal carbonate to about 4 percent by weight of the ground alkaline earth metal carbonate, an amount ranging from about 0.2 percent by weight of the ground alkaline earth metal carbonate to about 2 percent by weight of the ground alkaline earth metal carbonate, or an amount ranging from about 0.2 percent by weight of the ground alkaline earth metal carbonate to about 1.5 percent by weight of the ground alkaline earth metal carbonate. In some embodiments, the ratio of the amount of the carboxylic acid anhydride to the amount of stearic acid in the treatment agent may range from about 0.8:1 to about 1:0.8. In at least some such embodiments, the introduction of the treatment agent into the high-speed blender may include introducing the treatment agent in an amount ranging from about 0.1 percent by weight of the ground alkaline earth metal carbonate to about 10 percent by weight of the ground alkaline earth metal carbonate, for example, an amount ranging from about 0.5 percent by weight of the ground alkaline earth metal carbonate to about 8 percent by weight of the ground alkaline earth metal carbonate, an amount ranging from about 0.5 percent by weight of the ground alkaline earth metal carbonate to about 6 percent by weight of the ground alkaline earth metal carbonate, an amount ranging from about 0.5 percent by weight of the ground alkaline earth metal carbonate to about 4 percent by weight of the ground alkaline earth metal carbonate, an amount ranging from about 0.5 percent by weight of the ground alkaline earth metal carbonate to about 2 percent by weight of the ground alkaline earth metal carbonate, or an amount ranging from about 0.5 percent by weight of the ground alkaline earth metal carbonate to about 1.5 percent by weight of the ground alkaline earth metal carbonate, or an amount ranging from about 0.8 percent by weight of the ground alkaline earth metal carbonate to about one percent by weight of the ground alkaline earth metal carbonate.

In some embodiments, the surface-treated ground alkaline earth metal carbonate may include “free” or unreacted treatment agent equal to or less than about 2% by weight of the surface-treated ground alkaline earth metal carbonate. For example, the surface-treated ground alkaline earth metal carbonate may include unreacted treatment agent equal to or less than about 1% by weight of the surface-treated ground alkaline earth metal carbonate, equal to or less than about 0.9% by weight, about 0.8% by weight, about 0.7% by weight, about 0.6% by weight, about 0.5% by weight, about 0.4% by weight, about 0.3% by weight, about 0.2% by weight, or about 0.1% by weight of the surface-treated ground alkaline earth metal carbonate. According to at least some embodiments, the carboxylic acid anhydride-treated alkaline earth metal carbonate (e.g., alkenyl succinic anhydride-treated calcium carbonate) may include greater than about 75% less (e.g., about 80% less, about 90% less, or about 100% less) by weight “free” or unreacted carboxylic acid anhydride, as compared to stearic acid-treated calcium carbonate, for example, greater than about 70% less, greater than about 65% less, greater than about 60% less, greater than about 55% less, greater than about 50% less, greater than about 45% less, greater than about 40% less, greater than about 30% less, or greater than about 20% less by weight “free” or unreacted carboxylic acid anhydride, for example, as compared to stearic acid-treated calcium carbonate.

In some embodiments, a surface-treated alkaline earth metal carbonate may include the surface-treated alkaline earth metal carbonate obtained from one or more of the methods described herein. In some embodiments, a polymer composition may include the surface-treated alkaline earth metal carbonate obtained from one or more of the methods described herein and a polymer. The polymer composition may have one or more of the following characteristics: (a) the polymer may include one or more of a thermoplastic polymer, a thermosetting polymer, or an elastomeric polymer; or (b) the polymer composition may include between about one percent by weight and about 90 percent by weight of the surface-treated alkaline earth metal carbonate.

In some embodiments, a surface-treated alkaline earth metal carbonate may include a ground alkaline earth metal carbonate having a median particle size d₅₀ ranging from about 0.5 microns to about 20 microns, a top cut particle size d₉₈ ranging from about 2 microns to about 100 microns, and a BET surface area ranging from about 0.5 m²/g to about 20 m²/g. The surface-treated alkaline earth metal carbonate further may include a treatment agent including carboxylic acid anhydride bonded to a surface of the ground alkaline earth metal carbonate, thereby to form the surface-treated ground alkaline earth metal carbonate. The surface-treated ground alkaline earth metal carbonate also may include carboxylic acid bonded to the ground alkaline earth metal carbonate via a di-acid ligand.

In some embodiments, the surface-treated ground alkaline earth metal carbonate may have a thermal stability ranging from about 400 degrees F. to about 600 degrees F., for example, a thermal stability ranging from about 450 degrees F. to about 600 degrees F..

In some embodiments, the ground alkaline earth metal carbonate may have a median particle size d₅₀ ranging from about 1 micron to about 5 microns, a top cut particle size d₉₈ ranging from about 4 microns to about 30 microns, and a BET surface area ranging from about one m²/g to about 10 m²/g. In some embodiments, the ground alkaline earth metal carbonate may have a median particle size d₅₀ ranging from about 1.5 microns to about 3.5 microns, a top cut particle size d₉₈ ranging from about 5 microns to about 20 microns, and a BET surface area ranging from about one m²/g to about 10 m²/g.

In some embodiments, the ground alkaline earth metal carbonate (e.g., calcium carbonate) may have a median particle size d₅₀ ranging from about 0.1 microns to about 100 microns, for example, ranging from about 0.5 microns to about 10 microns. TABLE 2 below provides examples, according to at least some embodiments of the disclosure, of ground alkaline earth metal carbonate (e.g., ground calcium carbonate) treated with carboxylic acid anhydride (e.g., alkenyl succinic anhydride), including the corresponding medium particle size dso, top cut particle size d₉₈, BET surface area, and thermal stability. As shown by Examples 1-3, the thermal stability of each of the examples, according to at least some embodiments of the present disclosure, is about 550 degrees F., which is relatively higher than known examples of calcium carbonate treated with stearic acid, which may typically be expected to exhibit a thermal stability of about 440 degrees F.. A higher thermal stability, according to some embodiments, may result in higher processing temperatures and/or faster processing speeds when the carboxylic acid anhydride-treated alkaline earth metal carbonate is combined with at least some polymers during a melt-processing method, such as, for example, extrusion, molding, and/or mixing. For example, according to some embodiments, increased thermal stability may result in relatively faster processing speeds because, for example, extrusion at relatively higher temperatures may result in relatively reduced viscosity of the melting polymer composition, which may allow for relatively faster throughput.

TABLE 2
Example Ground Alkaline Earth Metal Carbonate

| | Median | Top Cut | | |
|---|---|---|---|---|
| | Particle | Particle | BET | Thermal |
| | Size d₅₀ | Size d₉₈ | Surface | Stability |
| Example | (microns) | (microns) | Area (m²/g) | (° F.) |
| 1 | 2.3 | 6.9 | 4.15 | 550 |
| 2 | 3.2 | 12.3 | 2.59 | 550 |
| 3 | 3.2 | 12.3 | 2.59 | 550 |

In some embodiments, a product may include a polymer composition as described herein, the product may be formed via one or more melt-processing methods, and the one or more melt-processing methods may include one or more of extrusion, molding, or mixing. In some embodiments, the product may include one or more of: a film; a stretched film; an un-stretched film; a breathable film; an extrusion coating; fibers; non-wovens; a molded product; a blow-molded product; a roto-molded product; a thermoformed product; an injection-molded product; or a product formed via additive manufacturing.

According to some embodiments, the products including the carboxylic acid anhydride-treated alkaline earth metal carbonate and polymer may exhibit one or more improvements or characteristics relative to products including stearic acid-treated calcium carbonate and polymer, including at least one of, for example: improved compound consistency, improved consistency in compound processing, reduced screen blinding during compounding, or reduced oxidation and wear during processing. According to some embodiments, the carboxylic acid anhydride-treated alkaline earth metal carbonate may be used as an agonist in the film structure around which pores form in at least one of biaxially-oriented polypropylene, microporous polyethylene, or films including at least of polyethylene or polypropylene. According to some embodiments, products including the carboxylic acid anhydride-treated alkaline earth metal carbonate and polymer may include at least one of a thin film, a product bag, or a garbage bag. According to some such embodiments, products including carboxylic acid anhydride-treated alkaline earth metal carbonate and polymer may exhibit one or more improvements or characteristics relative to products including stearic acid-treated calcium carbonate and polymer, including at least one of, for example: improved film consistency, improved printability, reduced VOC, reduced volatile liquids, improved opacity, or improved tensile strength. According to some embodiments, products including the carboxylic acid anhydride-treated alkaline earth metal carbonate and polymer may include at least one of an adhesive, a sealant, or a caulk. According to some such embodiments, products including carboxylic acid anhydride-treated alkaline earth metal carbonate and polymer may exhibit one or more improvements or characteristics relative to products including stearic acid-treated calcium carbonate and polymer, including at least one of, for example: improved stability, improved rheology, improved dispersion, or controlled reaction time. According to some embodiments, products including the carboxylic acid anhydride-treated alkaline earth metal carbonate and polymer may include at least one of rigid vinyl, rigid vinyl siding, rigid vinyl guttering, rigid vinyl decking, rigid vinyl fencing, or rigid vinyl window profiles. According to some such embodiments, products including carboxylic acid anhydride-treated alkaline earth metal carbonate and polymer may exhibit one or more improvements or characteristics relative to products including stearic acid-treated calcium carbonate and polymer, including at least one of, for example: improved room temperature impact strength, improved low temperature impact strength, or improved processability during extrusion. According to some embodiments, products including the carboxylic acid anhydride-treated alkaline earth metal carbonate and polymer may include a product produced by additive manufacturing techniques, such as, three-dimensional printing. According to some such embodiments, products including carboxylic acid anhydride-treated alkaline earth metal carbonate and polymer may exhibit one or more improvements or characteristics relative to products including stearic acid-treated calcium carbonate and polymer, including at least one of, for example: improved cooling rate, dimensional stability, or print reliability.

In some embodiments, products including the carboxylic acid anhydride-treated alkaline earth metal carbonate and polymer may include breathable film (e.g., stretched film), such as, for example, hygiene products such as diapers, feminine hygiene products, and adult incontinence products; construction products, such as construction membranes; and clothing and medical products, such as gowns (e.g., surgical gowns). In some embodiments, products including the carboxylic acid anhydride-treated alkaline earth metal carbonate and polymer may include films (e.g., blown films, cast films, and stretched films), such as, for example, packaging, wraps, shopping bags, and shrink-wrap film. In some embodiments, products including the carboxylic acid anhydride-treated alkaline earth metal carbonate and polymer may include extrusion coatings, such as, for example, for food packaging, juice packaging, drink packaging, other packaging such as tetrapack, and industrial containers. In some embodiments, products including the carboxylic acid anhydride-treated alkaline earth metal carbonate and polymer may include fibers and non-wovens, such as, for example, packaging, pouches, clothing, industrial products such as filters, and construction products such as geo textiles and membranes. In some embodiments, products including the carboxylic acid anhydride-treated alkaline earth metal carbonate and polymer may include molded products (e.g., blow-molded products), such as, for example, packaging such as bottles, and industrial products such as containers, tanks, road signs, and barriers. In some embodiments, products including the carboxylic acid anhydride-treated alkaline earth metal carbonate and polymer may include thermoformed products, such as, for example, packaging such as trays and cups. In some embodiments, products including the carboxylic acid anhydride-treated alkaline earth metal carbonate and polymer may include injection-molded products, such as, for example, packaging such as closures and caps, and agricultural products such as pots. Other types of products including the carboxylic acid anhydride-treated alkaline earth metal carbonate and polymer or other compositions are contemplated.

In some embodiments, a method for manufacturing a polymer product may include combining a surface-treated alkaline earth metal carbonate as described herein with a polymer composition. The method further may include processing the surface-treated alkaline earth metal carbonate and the polymer composition to form the polymer product. The polymer product may include between about one percent by weight and about 90 percent by weight of the surface-treated alkaline earth metal carbonate. In some embodiments, the processing may occur at a processing temperature ranging from about 450 degrees F. to about 550 degrees F..

According to at least some embodiments described herein, treating alkaline earth metal carbonate (e.g., calcium carbonate) with carboxylic acid anhydride (e.g., alkenyl succinic anhydride) relative to treating calcium carbonate with stearic acid, for example, may result in one or more relative enhancements. For example, for a given amount of alkaline earth metal carbonate having a given particle size and a given surface area, relatively less carboxylic acid anhydride may be needed to sufficiently treat the alkaline earth metal carbonate, as compared to the stearic acid. For example, for some examples, while about 0.1% to about 0.9% by weight of carboxylic acid anhydride (e.g., alkenyl succinic anhydride) may sufficiently treat an example alkaline earth metal carbonate (e.g., calcium carbonate), 0.5% to 2% by weight of stearic acid may be required to sufficiently treat the example alkaline earth metal carbonate.

Examples of additional enhancements provided by treatment with carboxylic acid anhydride relative to stearic acid further may include, for example, relatively improved affinity to the surface of alkaline earth metal carbonate by the carboxylic acid anhydride, relatively tighter adhesion of the carboxylic acid anhydride to the surface of the alkaline earth metal carbonate via a di-acid ligend, a relatively improved temperature stability of alkaline earth metal carbonate treated with carboxylic acid anhydride, for example, from about 400 degrees F. to about 600 degrees F. (e.g., from about 440 degrees F. to about 550 degrees F.), and/or a relatively lower moisture pick-up, possibly resulting from scavenging of water by the carboxylic acid anhydride. In some embodiments, one or more of these enhancements may result in improved performance by alkaline earth metal carbonates treated with carboxylic acid anhydride, for example, as compared to stearic acid-treated calcium carbonate, such as relatively higher loading in polymer compositions and/or relatively higher production speeds, for example, in melt-processing manufacturing methods, such as, for example, extrusion, molding, and/or mixing associated with polymer compositions including: (a) thermoplastic polymers, thermosetting polymers, or elastomeric polymers, and (b) alkaline earth metal carbonate treated with a treatment agent including carboxylic acid anhydride, according to at least some embodiments described herein. According to at least some embodiments, the carboxylic acid anhydride-treated alkaline earth metal carbonate (e.g., alkenyl succinic anhydride-treated calcium carbonate), as compared to known examples of calcium carbonate treated with stearic acid, when combined with polymers for melt processing, may yield products having relatively fewer defects and/or products having relatively improved mechanical properties.

### Comparison Test Results

Grinding tests were performed to determine the specific energy consumption for grinding (a) samples of a soft rock having a 4 millimeter (mm) size and a Mohs hardness of less than 2 according to embodiments of the disclosure and (b) comparison samples of hard rock having a 4 mm size and a Mohs hardness ranging from 2 to 3, to achieve a desired particle size distribution (psd), focusing on a ball mill and air classifier circuit to produce products ranging from fine to ultrafine. psd results were determined using a Sympatec® measurement system, which is based on laser diffraction technology, similar to the Malvern measurement system, as is known to those skilled in the art. The goal of the comparison test was to achieve four products, each having a different psd specification as follows: P1, having a mean psd D₅₀ ranging from 1.8 to 2.2 micrometers (microns); P2, having a mean psd D₅₀ ranging from 2.0 to 3.0 microns; P3, having a mean psd D₅₀ ranging from 3.0 to 4.0 microns; and P4, having a mean psd D₅₀ ranging from 4.8 to 5.8 microns.

The test milling was performed on (a) soft rock samples according to embodiments of the disclosure, a soft rock limestone, and (b) comparison samples, a hard rock. It should be noted that the distinction between soft rock and hard rock may not be entirely exact, for example, because the classification may be determined based on inherent characteristics of the raw material when extracted at the mine. To comprehensively assess the grindability of these materials and the required energy consumption, various products with different finesses, as noted above, were produced from both the soft rock and the hard rock during the milling test work performed at the test location.

For the purpose of testing, the equipment included a ball mill and an air classifier. In one test arrangement, the feeding system included a hopper with a screw conveyor as the discharge device. Two additional screw conveyors fed the fresh material and the coarse reject from the separator into the ball mill. The ball mill outlet material was blown into the separator by pneumatic conveyor. Fine material, separated by the air classifier, was collected in a bag house. The grinding aid was fed into the mill via the feed screw conveyor. In another test arrangement, the raw material was fed with a belt scale into the ball mill. From the outlet of the ball mill, the ground product was conveyed by a bucket elevator to the upper floor, where the material was dispersed into the primary airstream for air classification. The classifier rejects were returned to the ball mill for further comminution. The classifier fines were separated by a pocket filter from the airstream.

The milling testing systems were operated to achieve the desired product fineness noted above for each of the four specifications, P1-P4. Test work commenced after achieving stable operating conditions for each test. Table 3 through Table 6 below present the main parameters for the test production of P1, P2, P3, and P4 when processing samples S1-S4/S5 of the soft rock according to embodiments of the disclosure, and Table 7 through Table 10 below present the main parameters for the test production of P1, P2, P3, and P4 when processing the comparison samples C1-C4/C5 of the sample hard rock.

TABLE 3
Parameters for Achieving P1 From Soft Rock Samples

| Description | Units | Sample Number | | | |
|---|---|---|---|---|---|
| Sample number | — | S1 | S2 | S3 | S4 |
| Quantity of | [kg/h] | 66.9 | 68.0 | 68.2 | 48 |
| fines | | | | | |
| Classifier speed | [1/min] | 5,310 | 5,310 | 5,310 | 5,800 |
| Air volume | [Am³/h] | 1,200 | 1,200 | 1,200 | 9850 |
| Grinding aid | [%] | 0.12 | 0.12 | 0.12 | 0.12 |
| Ball mill | [kW] | 6.36 | 6.36 | 6.33 | 5.3 |
| absorbed power | | | | | |
| Specific | [kWh/t] | 95.07 | 95.53 | 92.82 | 95.7 |
| grinding energy | | | | | |
| D50 Sympatec | [μm] | 1.89 | 1.91 | 1.93 | 1.9 |
| D98 Sympatec | [μm] | 4.82 | 4.82 | 4.85 | 5.0 |

TABLE 4
Parameters for Achieving P2 From Soft Rock Samples

| Description | Units | Sample Number | | | |
|---|---|---|---|---|---|
| Sample number | — | S1 | S2 | S3 | S4 |
| Quantity of | [kg/h] | 84.2 | 83.0 | 82.2 | 60 |
| fines | | | | | |
| Classifier speed | [1/min] | 4,680 | 4,770 | 4,815 | 5,050 |
| Air volume | [Am³/h] | 1,207 | 1,207 | 1,207 | 1170 |
| Grinding aid | [%] | 0.1 | 0.11 | 0.118 | 0.12 |
| Ball mill | [kW] | 6.34 | 6.14 | 5.92 | 5.2 |
| absorbed power | | | | | |
| Specific | [kWh/t] | 75.53 | 76.39 | 77.01 | 80.2 |
| grinding energy | | | | | |
| D50 Sympatec | [μm] | 2.17 | 2.11 | 2.14 | 2.2 |
| D98 Sympatec | [μm] | 5.65 | 5.55 | 5.56 | 5.9 |

TABLE 5
Parameters for Achieving P3 From Soft Rock Samples

| Description | Units | Sample Number | | | | |
|---|---|---|---|---|---|---|
| Sample number | | S1 | S2 | S3 | S4 | S5 |
| Quantity of fines | [kg/h] | 132 | 130.1 | 131.7 | 128.1 | 141 |
| Classifier speed | [1/min] | 3,420 | 3,456 | 3,474 | 3,420 | 3,000 |
| Air volume | [Am³/h] | 1,225 | 1,225 | 1,225 | 1,225 | 1160 |
| Grinding aid | [%] | 0.085 | 0.086 | 0.085 | 0.087 | 0.10 |
| Ball mill absorbed power | [kW] | 6.39 | 6.39 | 6.39 | 6.39 | 5.2 |
| Specific grinding energy | [kWh/t] | 48.41 | 48.85 | 48.52 | 49.88 | 34.7 |
| D50 Sympatec | [μm] | 2.79 | 2.73 | 2.74 | 2.73 | 3.0 |
| D98 Sympatec | [μm] | 8.08 | 8.02 | 7.94 | 7.93 | 8.0 |

TABLE 6
Parameters for Achieving P4 From Soft Rock Samples

| Description | Units | Sample Number | | | | |
|---|---|---|---|---|---|---|
| Sample number | | S1 | S2 | S3 | S4 | S5 |
| Quantity of fines | [kg/h] | 300.6 | 295.2 | 291.0 | 297.6 | 190 |
| Classifier speed | [1/min] | 1,620 | 1,755 | 1,755 | 1,746 | 2,000 |
| Air volume | [Am³/h] | 1,219 | 1,219 | 1,219 | 1,219 | 1420 |
| Grinding aid | [%] | 0.056 | 0.057 | 0.058 | 0.056 | 0.08 |
| Ball mill absorbed power | [kW] | 6.75 | 6.72 | 6.72 | 6.7 | 5.3 |
| Specific grinding energy | [kWh/t] | 22.46 | 22.76 | 23.09 | 22.51 | 26.5 |
| D50 Sympatec | [μm] | 4.13 | 4.06 | 4.00 | 4.12 | 3.9 |
| D98 Sympatec | [μm] | 17.12 | 17.04 | 16.91 | 16.93 | 19.6 |

TABLE 7
Parameters for Achieving P1 From Comparison Hard Rock Samples

| Description | Units | Sample Number | | | | |
|---|---|---|---|---|---|---|
| Sample number | — | C1 | C2 | C3 | C4 | C5 |
| Quantity of fines | [kg/h] | 70.8 | 70.8 | 70.4 | 69.6 | 49.0 |
| Classifier speed | [1/min] | 5,175 | 5,175 | 5,175 | 5,175 | 5,800 |
| Air volume | [Am³/h] | 1,225 | 1,225 | 1,225 | 1,225 | 900 |
| Grinding aid | [%] | 0.117 | 0.117 | 0.118 | 0.119 | |
| Ball mill absorbed power | [kW] | 6.34 | 6.14 | 5.92 | 6.08 | 5.2 |
| Specific grinding energy | [kWh/t] | 93.50 | 92.23 | 91.62 | 92.67 | 93 |
| D50 Sympatec | [μm] | 1.90 | 1.94 | 1.92 | 1.94 | 1.9 |
| D98 Sympatec | [μm] | 4.86 | 4.89 | 4.88 | 4.95 | 4.9 |

TABLE 8
Parameters for Achieving P2 From
Comparison Hard Rock Samples

| Description | Units | Sample Number | | | |
|---|---|---|---|---|---|
| Sample number | — | C1 | C2 | C3 | C4 |
| Quantity of | [kg/h] | 91.22 | 91.71 | 91.56 | 77 |
| fines | | | | | |
| Classifier speed | [1/min] | 4,725 | 4,635 | 4,635 | 5,000 |
| Air volume | [Am³/h] | 1,225 | 1,225 | 1,225 | 1,212 |
| Grinding aid | [%] | 0.10 | 0.10 | 0.10 | 0.12 |
| Ball mill | [kW] | 6.38 | 6.38 | 6.38 | 5.4 |
| absorbed power | | | | | |
| Specific | [kWh/t] | 76.68 | 78.38 | 76.87 | 83.0 |
| grinding energy | | | | | |
| D50 Sympatec | [μm] | 2.15 | 2.10 | 2.12 | 2.1 |
| D98 Sympatec | [μm] | 5.71 | 5.67 | 5.68 | 6 |

TABLE 9
Parameters for Achieving P3 From Comparison Hard Rock Samples

| Description | Units | Sample Number | | | | |
|---|---|---|---|---|---|---|
| Sample number | — | C1 | C2 | C3 | C4 | C5 |
| Quantity of fines | [kg/h] | 132.6 | 134.4 | 137.1 | 132.6 | 145 |
| Classifier speed | [1/min] | 3,168 | 3,285 | 3,285 | 3285 | 2,700 |
| Air volume | [Am³/h] | 1,213 | 1,213 | 1,213 | 1,213 | 1,300 |
| Grinding aid | [%] | 0.12 | 0.11 | 0.11 | 0.11 | 0.10 |
| Ball mill absorbed power | [kW] | 6.43 | 6.41 | 6.39 | 6.39 | 5.3 |
| Specific grinding energy | [kWh/t] | 48.49 | 47.69 | 46.61 | 48.19 | 35.4 |
| D50 Sympatec | [μm] | 2.78 | 2.76 | 2.79 | 2.79 | 3.1 |
| D98 Sympatec | [μm] | 9.19 | 8.37 | 8.40 | 8.37 | 11.7 |

TABLE 10
Parameters for Achieving P4 From
Comparison Hard Rock Samples

| Description | Units | Sample Number | | | |
|---|---|---|---|---|---|
| Sample number | — | C1 | C2 | C3 | C4 |
| Quantity of | [kg/h] | 202.2 | 190.2 | 183 | 192 |
| fines | | | | | |
| Classifier speed | [1/min] | 1,269 | 1,530 | 1,530 | 2,050 |
| Air volume | [Am³/h] | 1,225 | 1,225 | 1,225 | 1,400 |
| Grinding aid | [%] | 0.09 | 0.09 | 0.09 | 0.08 |
| Ball mill | [kW] | 6.47 | 6.47 | 6.47 | 5.4 |
| absorbed power | | | | | |
| Specific | [kWh/t] | 32.0 | 34.0 | 35.36 | 27.0 |
| grinding energy | | | | | |
| D50 Sympatec | [μm] | 4.11 | 3.67 | 3.73 | 3.9 |
| D98 Sympatec | [μm] | 22.67 | 19.13 | 19.34 | 21.2 |

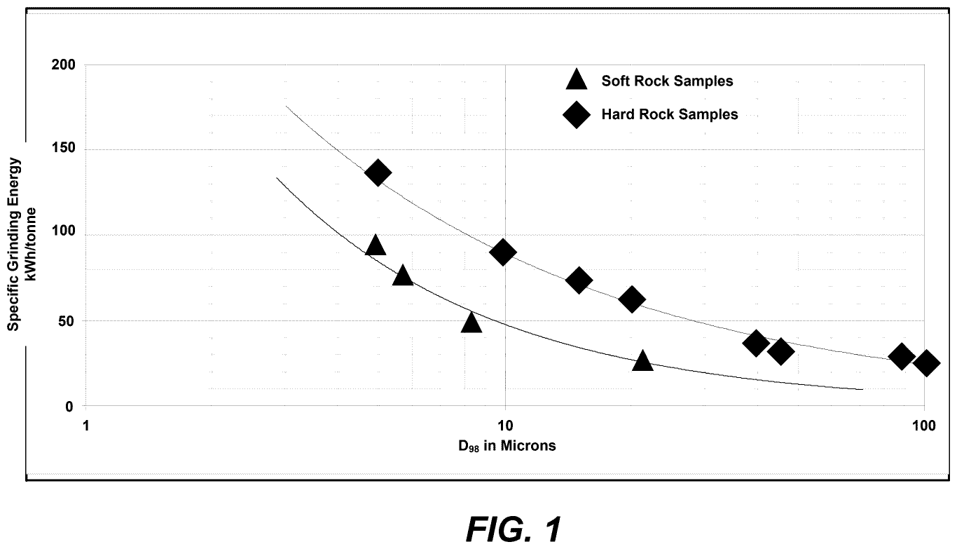

FIG. 1 is a graph showing test results showing specific grinding energy required in kilowatt-hours per tonne (kWh/t) to achieve the respective desired D₉₈ particle size for each of (a) the soft rock samples (i.e., limestone samples S1-S4/S5) according to embodiments of the disclosure and (b) the hard rock comparison samples (i.e., marble comparison samples C1-C4/C5). As shown in FIG. 1, the soft rock samples according to embodiments of the disclosure, consistently required less specific grinding energy as compared to the comparison hard rock samples across the range of desired D₉₈ particle sizes. For example, the soft rock samples according to embodiments of the disclosures consistently required about 50% less specific grinding energy as compared to the comparison hard rock samples across the range of desired D₉₈ particle sizes.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiments, and numerous variations, modifications, and additions further may be made thereto without departing from the spirit and scope of the present disclosure as set forth in the appended claims.

What is claimed is:

1. A method for processing alkaline earth metal carbonate, the method comprising:
introducing alkaline earth metal carbonate into a grinder to form ground alkaline earth metal carbonate, the ground alkaline earth metal carbonate having a median particle size dso ranging from about 0.5 microns to about 20 microns, a top cut particle size d₉₈ ranging from about 2 microns to about 100 microns, and a BET surface area ranging from about 0.5 square meters per gram (m²/g) to about 20 m²/g;
introducing the ground alkaline earth metal carbonate into a high-speed blender;
introducing a treatment agent into the high-speed blender, the treatment agent comprising a carboxylic acid anhydride; and
operating the high-speed blender, thereby to form a surface-treated ground alkaline earth metal carbonate, the surface-treated ground alkaline earth metal carbonate comprising carboxylic acid bonded to the ground alkaline earth metal carbonate via a di-acid ligand.

2. The method of claim 1, further comprising introducing water into the high-speed blender.

3. The method of claim 1, further comprising heating in the high-speed blender the ground alkaline earth metal carbonate and carboxylic acid anhydride to a temperature ranging from about 150 degrees Fahrenheit (F) to about 350 degrees F..

4. The method of claim 1, further comprising heating in the high-speed blender the ground alkaline earth metal carbonate and carboxylic acid anhydride to a temperature ranging from about 200 degrees Fahrenheit (F) to about 325 degrees F..

5. The method of claim 1, wherein the surface-treated ground alkaline earth metal carbonate has a thermal stability ranging from about 400 degrees Fahrenheit (F) to about 600 degrees F.

6. The method of claim 1, wherein the surface-treated ground alkaline earth metal carbonate has a thermal stability ranging from about 450 degrees Fahrenheit (F) to about 600 degrees F.

7. The method of claim 1, wherein the ground alkaline earth metal carbonate has a median particle size d₅₀ ranging from about 1 micron to about 5 microns, a top cut particle size d₉₈ ranging from about 4 microns to about 30 microns, and a BET surface area ranging from about 1 square meter per gram (m²/g) to about 10 m²/g.

8. The method of claim 1, wherein the ground alkaline earth metal carbonate has a median particle size d₅₀ ranging from about 1.5 microns to about 3.5 microns, a top cut particle size d₉₈ ranging from about 5 microns to about 20 microns, and a BET surface area ranging from about 1 square meter per gram (m²/g) to about 10 m²/g.

9. The method of claim 1, wherein introducing the treatment agent into the high-speed blender comprises introducing the treatment agent in an amount ranging from about 0.1 percent by weight of the ground alkaline earth metal carbonate to about 2 percent by weight of the ground alkaline earth metal carbonate.

10. The method of claim 1, wherein introducing the treatment agent into the high-speed blender comprises introducing the treatment agent in an amount ranging from about 0.1 percent by weight of the ground alkaline earth metal carbonate to about 0.9 percent by weight of the ground alkaline earth metal carbonate.

11. The method of claim 1, wherein the treatment agent further comprises stearic acid.

12. The method of claim 11, wherein a ratio of an amount of the carboxylic acid anhydride to an amount of stearic acid in the treatment agent ranges from about 1:5 to about 5:1.

13. The method of claim 12, wherein the introducing the treatment agent into the high-speed blender comprises introducing the treatment agent in an amount ranging from about 0.2 percent by weight of the ground alkaline earth metal carbonate to about 1.5 percent by weight of the ground alkaline earth metal carbonate.

14. The method of claim 12, wherein the ratio of the amount of the carboxylic acid anhydride to the amount of stearic acid in the treatment agent ranges from about 0.8:1 to about 1:0.8.

15. The method of claim 14, wherein the introducing the treatment agent into the high-speed blender comprises introducing the treatment agent in an amount ranging from about 0.8 percent by weight of the ground alkaline earth metal carbonate to about 1 percent by weight of the ground alkaline earth metal carbonate.

16. The method of claim 1, wherein the treatment agent comprises alkenyl succinic anhydride.

17. The method of claim 1, wherein the alkaline earth metal carbonate introduced into the high-speed blender has a purity ranging from about 98.6 percent to about 99.5 percent.

18. The method of claim 1, further comprising heating, via operation of the high-speed blender, the ground alkaline earth metal carbonate and the treatment agent to a temperature of at least about 250 degrees Fahrenheit (F).

19. The method of claim 1, further comprising drying, via operation of the high-speed blender, the surface-treated ground alkaline earth metal carbonate, such that the surface-treated ground alkaline earth metal carbonate has a moisture content equal to or less than about 0.2% by weight of the surface-treated ground alkaline earth metal carbonate.

20. The method of claim 1, wherein the surface-treated ground alkaline earth metal carbonate comprises unreacted treatment agent equal to or less than about 0.2% by weight of the surface-treated ground alkaline earth metal carbonate.

21. The method of claim 1, further comprising:
prior to introducing the ground alkaline earth metal carbonate into the high-speed blender, supplying unground alkaline earth metal carbonate to a grinder; and
operating the grinder to obtain the ground alkaline earth metal carbonate, the ground alkaline earth metal carbonate having a median particle size d₅₀ ranging from about 2 microns to about 7 microns, the operating the grinder comprising supplying an input power to the grinder ranging from about 2% to about 60% less than input power used in conventional grinding processes.

22. A surface-treated alkaline earth metal carbonate obtained from the method of claim 1.

23. A polymer composition comprising:
the surface-treated alkaline earth metal carbonate obtained from the method of claim 1; and
a polymer, wherein the polymer composition has one or more of the following characteristics:
(a) the polymer comprises one or more of a thermoplastic polymer, a thermosetting polymer, or an elastomeric polymer; or
(b) the polymer composition comprises between about one percent and about 90 percent by weight of the surface-treated alkaline earth metal carbonate.

24. A surface-treated alkaline earth metal carbonate, comprising:
a ground alkaline earth metal carbonate having a median particle size d₅₀ ranging from about 0.5 microns to about 20 microns, a top cut particle size d₉₈ ranging from about 2 microns to about 100 microns, and a BET surface area ranging from about 0.5 square meters per gram (m²/g) to about 20 m²/g; and
a treatment agent comprising carboxylic acid anhydride bonded to a surface of the ground alkaline earth metal carbonate, thereby to form the surface-treated ground alkaline earth metal carbonate, the surface-treated ground alkaline earth metal carbonate comprising carboxylic acid bonded to the ground alkaline earth metal carbonate via a di-acid ligand.

25. The surface-treated alkaline earth metal carbonate of claim 24, wherein the surface-treated ground alkaline earth metal carbonate has a thermal stability ranging from about 400 degrees Fahrenheit (F) to about 600 degrees F..

26. The surface-treated alkaline earth metal carbonate of claim 24, wherein the surface-treated ground alkaline earth metal carbonate has a thermal stability ranging from about 450 degrees Fahrenheit (F) to about 600 degrees F..

27. The surface-treated alkaline earth metal carbonate of claim 24, wherein the ground alkaline earth metal carbonate has a median particle size d₅₀ ranging from about 1 micron to about 5 microns, a top cut particle size d₉₈ ranging from about 4 microns to about 30 microns, and a BET surface area ranging from about 1 square meter per gram (m²/g) to about 10 m²/g.

28. The surface-treated alkaline earth metal carbonate of claim 24, wherein the ground alkaline earth metal carbonate has a median particle size d₅₀ ranging from about 1.5 microns to about 3.5 microns, a top cut particle size d₉₈ ranging from about 5 microns to about 20 microns, and a BET surface area ranging from about 1 square meter per gram (m²/g) to about 10 m²/g.

29. The surface-treated alkaline earth metal carbonate of claim 24, wherein the treatment agent further comprises stearic acid.

30. The surface-treated alkaline earth metal carbonate of claim 29, wherein a ratio of an amount of the carboxylic acid anhydride to an amount of stearic acid in the treatment agent ranges from about 1:5 to about 5:1.

31. The surface-treated alkaline earth metal carbonate of claim 29, wherein the treatment agent comprises an amount ranging from about 0.2 percent by weight of the ground alkaline earth metal carbonate to about 1.5 percent by weight of the ground alkaline earth metal carbonate.

32. The surface-treated alkaline earth metal carbonate of claim 29, wherein the ratio of the amount of the carboxylic acid anhydride to the amount of stearic acid in the treatment agent ranges from about 0.8:1 to about 1:0.8.

33. The surface-treated alkaline earth metal carbonate of claim 32, wherein the treatment agent comprises an amount ranging from about 0.8 percent by weight of the ground alkaline earth metal carbonate to about 1 percent by weight of the ground alkaline earth metal carbonate.

34. The surface-treated alkaline earth metal carbonate of claim 24, wherein the ground alkaline earth metal carbonate has a purity ranging from about 98.6 percent to about 99.5 percent.

35. A polymer composition comprising:
the surface-treated alkaline earth metal carbonate of claim 24; and
a polymer, wherein the polymer composition has one or more of the following characteristics:
(a) the polymer comprises one or more of a thermoplastic polymer, a thermosetting polymer, or an elastomeric polymer; or
(b) the polymer composition comprises between about one percent and about 90 percent by weight of the surface-treated alkaline earth metal carbonate.

36. A product comprising the polymer composition of claim 35, wherein the product is formed via one or more melt-processing methods, the one or more melt-processing methods comprising one or more of extrusion, molding, or mixing.

37. The product of claim 36, wherein the product comprises one or more of:
an extruded product;
a film;
a stretched film;
an un-stretched film;
a breathable film;
an extrusion coating;
fibers;
non-wovens;
a molded product;
a blow-molded product;
a roto-molded product;
a thermoformed product;
an injection-molded product; or
a product formed via additive manufacturing.

38. A method for manufacturing a polymer product, the method comprising:
combining the surface-treated alkaline earth metal carbonate of claim 34 with a polymer composition; and
processing the surface-treated alkaline earth metal carbonate and the polymer composition to form the polymer product, wherein the polymer product comprises between about one percent by weight and about 90 percent by weight of the surface-treated alkaline earth metal carbonate.

39. The method of claim 38, wherein the processing occurs at a processing temperature ranging from about 450 degrees Fahrenheit (F) to about 550 degrees F..
